(19) United States
(12) Patent Application Publication
(10) Pub. No.: US 2019/0292978 A1
(43) Pub. Date: Sep. 26, 2019

(54) PISTON CROWN

(71) Applicant: Perkins Engines Company Limited, Peterborough (GB)

(72) Inventors: Vivian Page, Lincolnshire (GB); Rukmangadhan Govindarajan, Lincolnshire (GB)

(73) Assignee: Perkins Engines Company Limited, Peterborough (GB)

(21) Appl. No.: 16/348,773

(22) PCT Filed: Nov. 27, 2017
(86) PCT No.: PCT/EP2017/080572

§ 371 Date: May 9, 2019

(30) Foreign Application Priority Data
Dec. 2, 2016 (GB) 1620510.6

(51) Int. Cl. F02B 23/06; F02F 3/26

(52) U.S. Cl. CPC F02B 23/0672; F02F 3/26; F02B 23/0669

(57) ABSTRACT

The disclosure provides a piston crown for a piston mountable in a combustion cylinder of an internal combustion engine. The piston crown includes a top annular surface. Radially inside the top annular surface is a piston bowl for guiding fuel injected into the combustion cylinder. The piston bowl includes a frusto-conical lip chamfer surface at a throat of the piston bowl next to the annular surface. In diametric cross-section the lip chamfer surface has a radius of at least 30 mm, preferably 30 mm.

### TECHNICAL FIELD

This disclosure relates generally to piston bowls for internal combustion engines.

### BACKGROUND

Increasing engine efficiency and reducing emissions is a desire of engine manufacturers and users alike.

Combustion characteristics within a combustion chamber of an engine may be influenced by, among other things, shape of the combustion chamber and injection characteristics of fuel injected into the combustion chamber. In this way, factors such as fuel combustion efficiency and the composition of combustion emissions may be influenced. Composition of combustion emissions includes an extent to which combustion produces NOₓ and particulate matter, such as soot.

An engine may have a combustion chamber bounded by an interior surface of a combustion cylinder and a top surface of a piston that reciprocates within the combustion cylinder. In such a combustion chamber, it is possible to influence combustion characteristics by altering the top surface of the piston that faces a fuel injector configured to inject fuel into the combustion cylinder. It is also possible to influence combustion characteristics by altering the distribution of fuel injected into the combustion chamber.

It is known to provide a variety of different piston bowls within the top surface of the piston. The shape of a combustion bowl may be dictated by, among other things, whether it is intended for the fuel to target a feature of the piston bowl in order to distribute fuel vapour within the bowl (known as a targeted piston bowl) or it is intended for the fuel to be guided by the bowl without making a targeted impact (known as a spray guided piston bowl). Whether a piston bowl is employed for targeted or spray guided use is also governed by the manner of fuel injection within the cylinder. Injection behaviour may be governed, among other things, by the number and arrangement of injection orifices, including the angle of such orifices relative to the combustion cylinder. The present disclosure relates to spray guided piston bowls.

Given increases in engine efficiency and changes to regulatory regimes, there may be a desire to produce smaller engines. However, for various reasons, it may not be appropriate simply to scale all dimensions of a combustion cylinder and piston. One reason for this may be that fuel injection behaviour may not be easily scalable and/or, to the extent that fuel injection behaviour may be scalable, it may be undesirable for other reasons.

In producing smaller engines, it may be desirable to increase a swirl ratio, that being defined as angular rotational speed of trapped gases within the cylinder about the cylinder axis divided by engine speed. This may be desirable in order to promote efficient mixing of the fuel and air and limit the penetration of the combusting gases.

The present disclosure relates to spray guided piston bowls developed from larger prior art spray guided piston bowls (as illustrated in FIGS. 3 and 4). The piston bowls of the present disclosure may be suitable for a smaller diameter combustion cylinder with high efficiency and low emissions.

### SUMMARY OF DISCLOSURE

Against this background, there is provided a piston crown for a piston of an internal combustion engine, the piston crown extending in an axial direction along a central axis and in a radial direction outwardly from the central axis, the piston crown comprising: an annular surface at a first end of the piston crown in the axial direction; and a piston bowl located radially within the annular surface and recessed relative to the first end of the piston crown; wherein the piston bowl comprises:
a bowl floor having an axis of rotation coincident with the central axis of the piston crown, the bowl floor comprising a frusto-conical portion tapering in a direction of the first end of the piston crown towards a spherical cap portion capping the frusto-conical portion;
an arcuate surface located radially outward relative to the bowl floor;
a circumferential surface parallel to the central axis of the piston bowl at a radially outward end of the arcuate surface; and
a frusto-conical lip chamfer surface extending radially outwardly from the circumferential portion of the arcuate surface and radially inwardly from the annular surface and tapering away from the first end of the piston crown;
wherein in diametric cross-section the lip chamfer surface has a radius of at least 30 mm, preferably 30 mm.

### BRIEF DESCRIPTION OF THE DRAWINGS

FIG. 1 shows a cross-sectional schematic view of one end of a piston including a piston bowl in accordance with an aspect of the disclosure in situ in an engine cylinder;

FIG. 2 shows a cross-sectional schematic view of the piston of FIG. 1;

FIG. 3 shows a cross-sectional schematic view of a first prior art piston bowl, for purposes of comparison;

FIG. 4 shows a cross-sectional schematic view of a second prior art piston bowl, for purposes of comparison;

FIG. 5 shows a cross-sectional schematic view of a first option of a lip geometry of the piston bowl of FIG. 1;

FIG. 6 shows a cross-sectional schematic view of a second option of a lip geometry of the piston bowl of FIG. 1;

FIG. 7 shows a cross-sectional schematic view of an injector suitable for use with the piston bowl of the present disclosure;

FIG. 8 provides a graph showing performance of the piston bowl of FIGS. 1 and 2 versus prior art the piston bowl such as those of FIGS. 3 and 4; and

FIG. 9 provides a graph showing performance of the piston bowl of FIGS. 1 and 2 versus prior art the piston bowl such as those of FIGS. 3 and 4.

### DETAILED DESCRIPTION

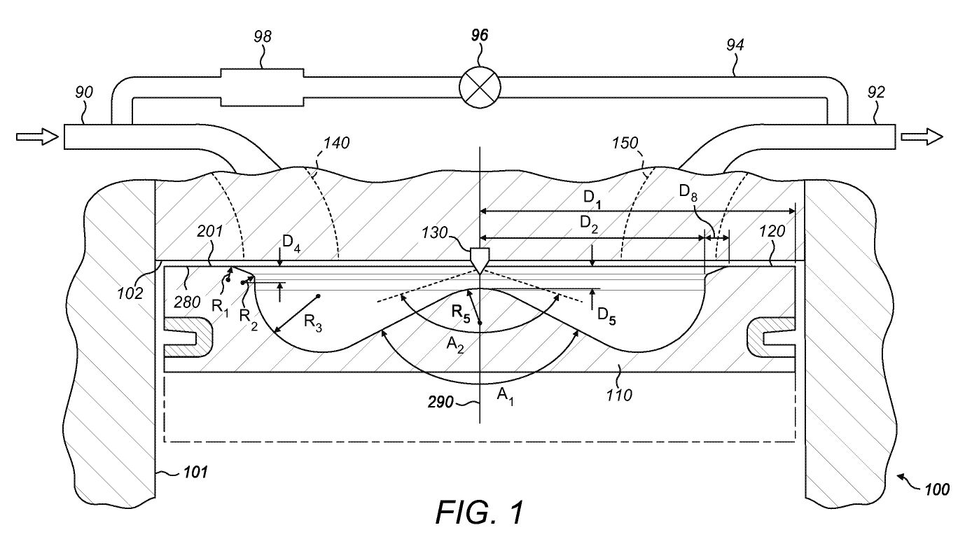

FIG. 1 shows a cross section through a cylinder 100 of an internal combustion engine together with related features. The cylinder may comprise an internal bore 101. The internal bore 101 may accommodate a piston 110. The piston 110 may be coaxial with the internal bore 101 of the cylinder 100 such that the piston 110 is movable relative to the cylinder 100 in an axial direction.

The cylinder 100 may comprise a fuel injector 130 located a top end 102 of the cylinder 100. The fuel injector 130 may be located coaxially with the internal bore 101 of the cylinder such that fuel injected by the fuel injector 130 may enter the internal bore 101 at the axis. The fuel injector 130 may comprise a fuel injector head (not shown) for distributing fuel in accordance with a desired geometrical arrangement.

The piston 110 comprises a piston crown 120 and a piston body (not shown but located underneath the piston crown 120 in the orientation of FIG. 1). The piston crown 120 may be at a head end of the piston 110 such that the piston crown 120 of the piston 110 faces the fuel injector 130.

The cylinder 100 may further comprise an oxidant inlet 140 for selectively allowing inlet of an oxidant, such as air, to facilitate combustion and an exhaust outlet 150 for selectively allowing release of combustion products from the cylinder 100. The oxidant inlet 140 and the exhaust outlet 150 may be located at the top end 102 of the cylinder 100 adjacent the fuel injector 130.

An intake passage 90 is in fluid communication with, and configured to supply air to, cylinder 100, and an exhaust passage 92 is also in fluid communication with, and conveys combustion products out of, cylinder 100. Intake valves and exhaust valves are not shown in FIG. 1, but will typically be provided in a conventional manner. An exhaust gas recirculation loop 94 may connect passages 90 and 94, and may have an exhaust recirculation control valve 96 and an exhaust gas cooler 98 positioned therein.

In FIG. 1, the piston 110 is shown relative to the cylinder 110 at a position in its oscillating cycle that is closest to the top end 102 of the cylinder 100.

The piston crown 120 has an axial direction that sits vertically in the orientation of FIG. 1 and a radial direction that sits horizontally in the orientation of FIG. 1. The piston crown 120 may be rotationally symmetrical about a central axis 290 in the axial direction. The central axis 290 of the piston crown 120 may, when in situ in the cylinder, be coaxial with a central axis of the fuel injector 130.

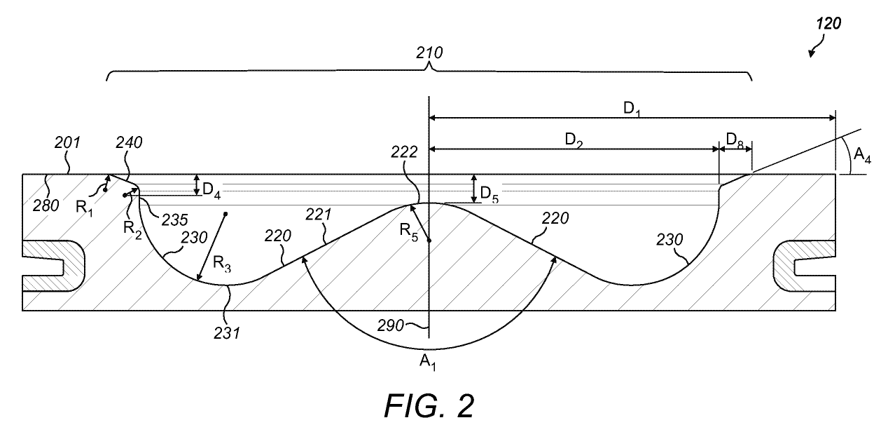

FIG. 2 shows the piston of FIG. 1 in isolation from the cylinder 100. Referring to FIG. 2, the piston crown 120 comprises an annular surface 201 at a first end 280 of the piston crown 120 in the axial direction that, when in situ in the cylinder 100, faces the fuel injector 130. The annular surface 201 may be radially furthest from the central axis 290.

The piston crown 120 further comprises a piston bowl 210 located radially within the annular surface 201 and recessed relative to the first end 280 of the piston crown.

The piston bowl 210 comprises a raised floor 220 in a radially central region of the piston bowl 120. The piston bowl 210 further comprises an arcuate surface 230 located radially outward relative to the raised floor 220. The piston bowl 210 further comprises a circumferential surface 235 parallel to the axis of the piston bowl 210 and located radially outward relative to the arcuate surface 230. The piston bowl 210 further comprises a lip chamfer surface 240 extending radially outwardly from the circumferential surface 235 and radially inwardly from the annular surface 201.

The raised floor 220 comprises a frusto-conical surface 221 tapering in a direction of the first end 280 of the piston crown towards a spherical cap 222 that caps the frusta-conical surface 221. An angle of the frusto-conical surface 221 relative to a plane orthogonal to the axis 290 may be the same as an angle of the lowest portion of the spherical cap 222 so as to avoid any surface discontinuity at the interface between the frusto-conical surface 221 and the spherical cap 222. Put another way, a diameter of the frusto-conical surface 221 at its smaller end may be the same as a widest dimension of the spherical cap 222. Furthermore, the diameter of the frusto-conical surface 221 may be aligned with the widest dimension of the spherical cap 222.

The arcuate surface 230, when the piston 120 is viewed in diametric cross section, may have a single radius between where the arcuate surface 230 interfaces with a radially outermost end of the frusto-conical surface 221 and where the arcuate surface 230 interfaces with the circumferential surface 235 parallel to the axis of the piston bowl 210.

The lip chamfer surface 240 that extends radially outwardly from the circumferential surface 235 and radially inwardly from the annular surface 201 tapers such that a widest portion of the piston bowl 210 is at its entrance. Its entrance is location in a plane shared with the annular surface 201 at the first end of the piston crown 280.

The cylinder 100 in which the piston 120 reciprocates may have a radius D₁ such that an overall diameter of the cylinder 100 may be 2D₁. A diameter of a largest part of the piston 120 is smaller than 2D₁. The circumferential surface 235 of the piston 120 may have a radius D₂ such that the diameter of the circumferential surface 235 may be 2D₂. The lip chamfer surface 240 may have a radial dimension D₈. In this way, a diameter of the piston bowl throat in the plane of the annular surface 201 may be 2(D₂+D₈). A dimension along the axis of the piston between the plane of the annular surface 201 and a part of the spherical cap closest thereto may be D₅.

An angle between opposing straight line portions (that is, when viewed in diametric cross-section) of the frusto-conical surface 221 may be A₁. For comparison purposes, an angle between axes of injector orifices configured to inject fuel into the cylinder may be A₂.

A radius of curvature between the annular surface 201 and the lip chamfer surface 240 may be R₁, and in some embodiments R₁ may be zero. A radius of curvature between the lip chamfer surface 240 and the circumferential surface 235 may be R₂. A radius of curvature of the arcuate surface 230 may be R₃. A radius of curvature of the spherical cap 222 may be R₅.

For the avoidance of doubt, the radii of curvature R₁, R₂, R₄ and R₅ are those identifiable in diametric cross-section through the axis of the piston 120. It should be noted that, for clarity, the radii marked on the Figures are drawn to arbitrary lengths and do not relate in any way to the absolute length or to the relative length of the radii they represent.

A dimension in an axial direction between the annular surface 201 and the origin of the radius R₂ may be D₄.

In a first embodiment, the lip chamfer surface 240 may be a straight line between an inner end of the radii R₁ and an outer end of the radii R₂, when viewed in diametric cross-section through the axis of the piston 120. An angle between the straight line of the lip chamber surface 240 and the annular surface 201 may be A₄. This is shown in more detail in FIG. 5, albeit highly schematically.

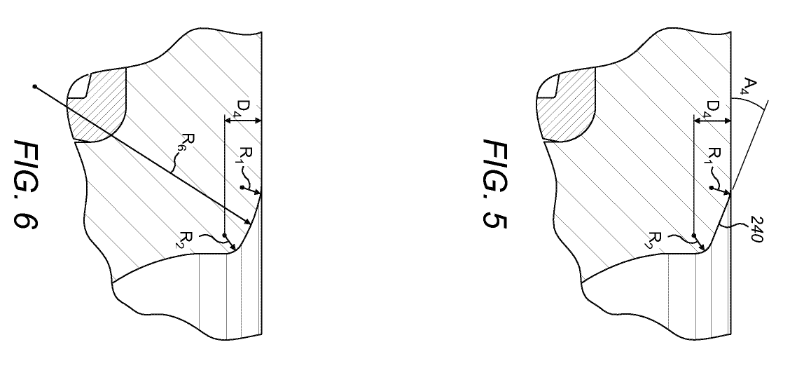

In a second embodiment, the lip chamfer surface 240 may be curved between an inner end of the radii R₁ and an outer end of the radii R₂, when viewed in diametric cross-section through the axis of the piston 120. The radius of curvature of the lip chamfer surface 240 in such an embodiment may be R₆. This is shown in FIG. 6, albeit highly schematically, particularly since R₆ may be sufficiently large as not to be immediately identifiable at the scale shown in FIG. 6. An angle between a tangent to the radius R₆ and the annular surface 201 may be A₄ (for clarity, the tangent and angle are not shown in FIG. 6).

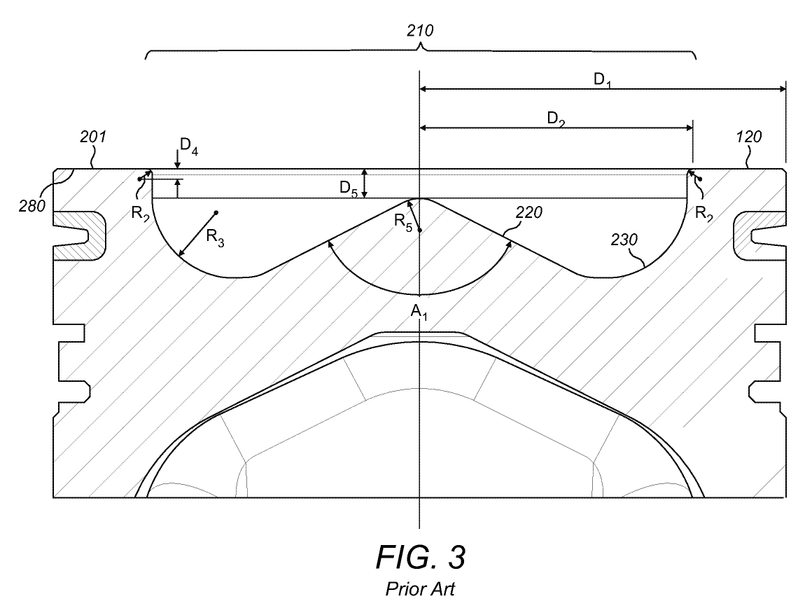

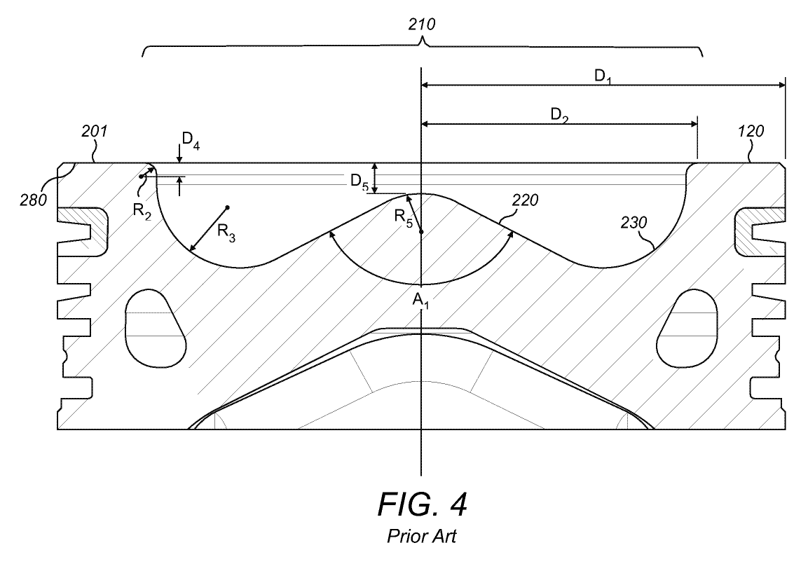

In the case of either the FIG. 5 or the FIG. 6 embodiment, the value A₄ may be between 19° and 21°. Preferably the value A₄ may be 20°. Some specific exemplary Figures for the parameters described above and identified in the Figures are provided in the table below. FIGS. 1, 2, 5 and 6 show embodiments of the present disclosure while FIGS. 3 and 4 relate to prior art piston bowls.

| | FIGS. 1, 2, 5 & 6 | FIG. 3 | FIG. 4 |
|---|---|---|---|
| R₁ | 0 mm | n/a | n/a |
| R₂ | 1.5 mm | 1.5 mm | 1.5 mm |
| R₃ | 10.5 mm | 12 mm | 12 mm |
| R₅ | 10 mm | 9.98 mm | 10 mm |
| R₆ | n/a or >30 degrees | n/a | n/a |
| A₁ | 125.7 degrees | 125 degrees | 125 degrees |
| A₂ | 130 degrees | 130 degrees | 130 degrees |
| A₂ minus A1 | 4.3 degrees | 5 degrees | 5 degrees |
| A₄ | 20 degrees | n/a | n/a |
| D₁ (bore radius) | 49 mm | 52.5 mm | 52.5 mm |
| D₂ | 34.95 mm | 38.3 mm | 38.3 mm |
| D₄ | 2.49 mm | 1.5 mm | 1.5 mm |
| D₅ | 3.55 mm | 4.81 mm | 3.97 mm |
| D₈ | 3.95 mm | 0 mm | 0 mm |
| Number of injector | 6 | 6 | 6 |
| orifices | | | |
| Bowl volume | 42.1 cm3 | 58.5 cm3 | 54.6 cm3 |
| Compression ratio | 17.0:1 | 16.5:1 | 16.5:1 |
| Swirl ratio | 1.8 | 0.4 | 0.6 |

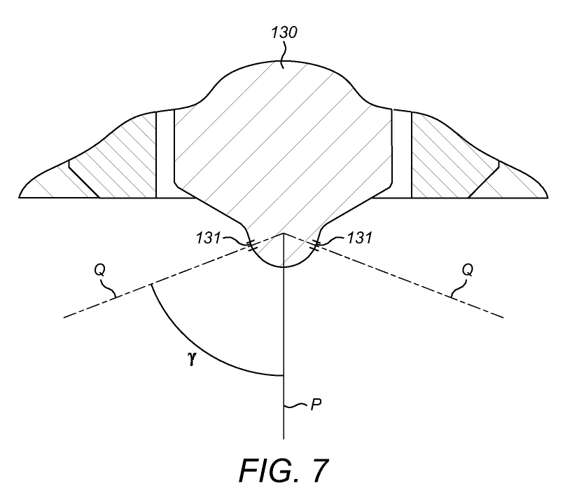

In use, fuel may be injected into the combustion chamber from an injector 130 shown in FIGS. 1 and 7. The injector 130 may comprise a plurality of spray discharge orifices 131 through which fuel may be injected. In a specific embodiment, the number of spray discharge orifices 131 may be six (6).

Each spray discharge orifice 131 may have a central axis Q. Central axis Q may pass through the centre point of each spray discharge orifice 131. In an embodiment, each central axis Q may be transverse to a plane extending across each respective spray discharge orifice 131. In an embodiment, each spray discharge passage has a longitudinal axis that is coincident with central axis Q of respective spray discharge orifice 131. Each respective spray discharge passage may extend along the central axis Q. In an embodiment, each central axis Q may be normal to a plane extending across each respective inlet.

Each central axis Q may have an angle γ relative to a central axis P of the injector 130, which may be coincident with the central axis of the piston 290. Each central axis Q may have an angle γ of approximately 64.5 to 65.5 relative to the central axis P. Each central axis Q may have an angle γ of approximately 65 relative to the central axis P.

Fuel injector 10 may have a spray cone angle A₂ (see FIG. 1) that is defined by angle 2γ (see FIG. 7). Accordingly, fuel vapour from the plurality of spray discharge orifices 131 may be discharged with a spray cone angle of approximately 129° to 131°. Fuel vapour from the plurality of spray discharge orifices 131 may be discharged with a spray cone angle of approximately 130°.

Fuel may be discharged from the plurality of spray discharge orifices 131 at a flow rate of 680 to 720 cc/min. Fuel may be expelled from the plurality of spray discharge orifices 131 at a flow rate of 700 cc/min.

As mentioned previously, a swirl ratio may be defined as angular rotational speed about the cylinder axis. In the preferred embodiment, a swirl ratio of 1.8 may be employed. This may promote efficient mixing of the fuel and air and avoid combustion products residing in specific areas that may affect engine durability.

The lip chamfer surface 240 may be particularly beneficial in a piston of reduced size since it promotes distribution of fuel leaving the piston bowl. As distinct from the prior art embodiments of FIGS. 3 and 4 which have larger combustion volumes, the lip chamfer surface 240 of the embodiments of the present disclosure may encourage improved fuel distribution for improved thermal distribution and improved combustion efficiency, perhaps most particularly applicable in a combustion cylinder operating a fuel injector with a swirl ratio of approximately 1.8.

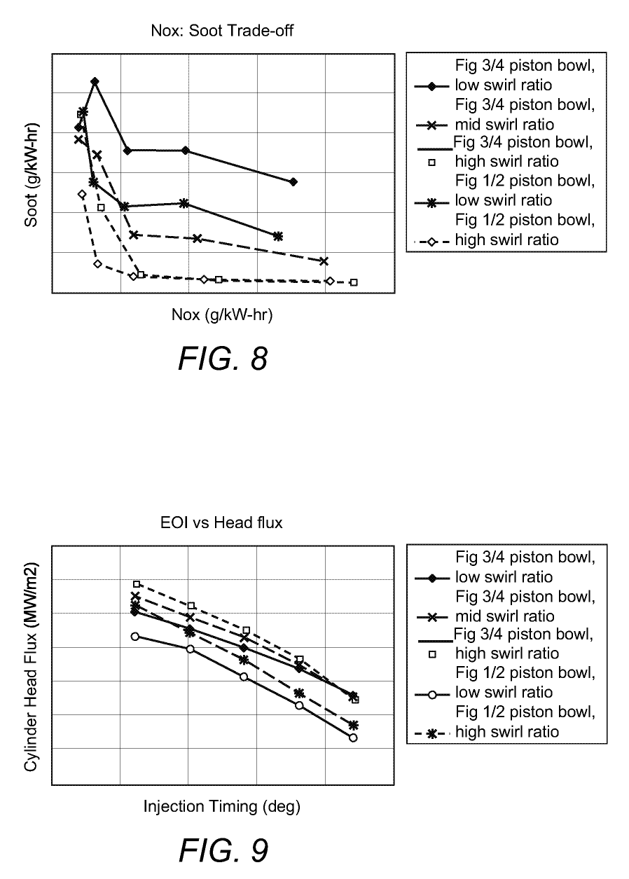

FIG. 8 provides a plot of soot against NOₓ for piston bowls in accordance with the disclosure (e.g. FIGS. 1 and 2) relative to piston bowls of the prior art (e.g. FIGS. 3 and 4). As can be seen, the piston bowl of the present disclosure provides lower soot than the piston bowl of the prior art, when using the same swirl ratio.

FIG. 9 provides a plot of flux versus injection timing and shows plots both for piston bowls in accordance with the prior art (e.g. FIGS. 3 and 4) and piston bowls of the present disclosure (e.g. FIGS. 1 and 2).

### INDUSTRIAL APPLICABILITY

The present disclosure relates to a spray guided piston bowl that may be applicable to a diesel engine for achieving improved fuel to air mixing that in turn results in more efficient combustion and reduced NOₓ and/or particulate emissions.

The piston may be of aluminium. The engine may be based on a known larger engine with a reduced piston diameter and volume and adapted to improve efficiency and to target specific emissions outputs.

1. A piston crown for a piston of an internal combustion engine, the piston crown extending in an axial direction along a central axis and in a radial direction outwardly from the central axis, the piston crown comprising: an annular surface at a first end of the piston crown in the axial direction; and a piston bowl located radially within the annular surface and recessed relative to the first end of the piston crown; wherein the piston bowl comprises:
a raised floor having an axis of rotation coincident with the central axis of the piston crown, the raised floor comprising a frusto-conical portion tapering, in a direction of the first end of the piston crown towards a spherical cap portion capping the frusto-conical portion;
an arcuate surface located radially outward relative to the raised floor;
a circumferential surface parallel to the central axis of the piston bowl at a radially outward end of the arcuate surface; and
a lip chamfer surface extending radially outwardly from the circumferential portion of the arcuate surface and radially inwardly from the annular surface and tapering away from the first end of the piston crown;
wherein in diametric cross-section the lip chamfer surface has a radius of at least 30 mm, preferably 30 mm.

2. The piston crown of claim 1 wherein the diameter of the circumferential surface is between 69.7 mm and 70.1 mm, preferably, 69.9 mm.

3. The piston crown of claim 1 wherein a component of length of the frusto-conical lip chamfer surface in the axial direction, measured from the annular surface to an origin of a radius defining a curve between the frusto-conical lip chamfer surface and the circumferential surface, is between 1.36 mm and 1.40 mm, preferably 1.38 mm.

4. The piston crown of claim 1 wherein in diametric cross-section an included angle between opposing sides of the frusto-conical portion is between 125.2° and 126.2°, and is preferably 125.7°.

5. The piston crown of claim 1 wherein in diametric cross-section the arcuate surface comprises a circular arc having a radius of 10.5 mm.

6. The piston crown of claim 1 configured to be accommodated within a combustion cylinder having a diameter of between 97.9 mm and 98.1 mm, preferably 98 mm.

7. The piston crown of claim 1 wherein the spherical cap portion has a radius of curvature of between 9.9 mm and 10.1 mm, preferably 10 mm.

8. The piston crown of claim 1 wherein a radius of curvature between the annular surface and the lip chamfer surface may be between 29 mm and 31 mm, preferably 30 mm.

9. The piston crown of claim 1 wherein a radius of curvature between the lip chamfer surface and the circumferential surface may be between 1.4 mm and 1.6 mm, preferably 1.5 mm.

10. A combustion cylinder comprising a piston having a piston bowl of claim 1 and a fuel injector mounted at an end of the combustion cylinder facing the piston bowl wherein the fuel injector comprises a plurality of fuel spray discharge orifices arranged so as to provide a fuel injection cone angle of between 129° and 131°, preferably 130°.

11. The combustion cylinder of claim 10 wherein a difference between the fuel injection cone angle and an angle between opposing sides of the frusto-conical portion is between 4.1° and 4.3°, preferably 4.2°.

12. The combustion cylinder of claim 10 wherein the injector is configured to provide a swirl ratio of between 1.7 and 1.9, preferably 1.8.

13. An internal combustion engine comprising a combustion cylinder of claim 10 and an intake valve and an exhaust valve.

14. A method of manufacturing a combustion cylinder comprising providing a cylinder and installing within it a piston having a piston crown of any of claim 1.

15. A method of increasing efficiency of an internal combustion, engine comprising the steps of providing a piston to reciprocate within a cylindrical combustion chamber, the piston comprising a piston crown extending in an axial direction along a central axis and in a radial direction outwardly from the central axis, the piston crown comprising: an annular surface at a first end of the piston crown in the axial direction; and a piston bowl located radially within the annular surface and recessed relative to the first end of the piston crown; wherein the piston bowl comprises:
a raised floor having an axis of rotation coincident with the central axis of the piston crown, the raised floor comprising a frusto-conical portion tapering in a direction of the first end of the piston crown towards a spherical cap portion capping the frusto-conical portion;
an arcuate surface located radially outward relative to the raised floor;
a circumferential surface parallel to the central axis of the piston bowl at a radially outward end of the arcuate surface; and
a lip chamfer surface extending radially outwardly from the circumferential portion of the arcuate surface and radially inwardly from the annular surface and tapering away from the first end of the piston crown;
wherein in diametric cross-section the lip chamfer surface has a radius of at least 30 mm, preferably 30 mm.
